(19) United States
(12) Patent Application Publication
(10) Pub. No.: US 2026/0158936 A1
(43) Pub. Date: Jun. 11, 2026

(54) METHOD FOR THE ENERGY-OPTIMAL SPECIFICATION OF A DRIVING SPEED

(71) Applicant: MERCEDES-BENZ GROUP AG, Stuttgart (DE)

(72) Inventors: Alexander HANUSCHKIN, Karlsruhe (DE); Gerrit ECKE, Hechingen-Sickingen (DE)

(21) Appl. No.: 18/874,140

(22) PCT Filed: May 26, 2023
(86) PCT No.: PCT/EP2023/064291

§ 371 Date: Dec. 12, 2024

(30) Foreign Application Priority Data
Jun. 15, 2022 (DE) 10 2022 002 172.2

(51) Int. Cl. B60L 15/20; B60W 40/02; G01C 21/36

(52) U.S. Cl. CPC B60L 15/2045; B60W 40/02; G01C 21/3691

(57) ABSTRACT

Energy-optimal specification of a current vehicle speed at a selected desired average speed of a planned route, taking into account a wind distribution along the route, is provided. The wind distribution is provided by a server external to the vehicle in the form of wind values for several successive positions along or in the local region of the planned route. Local wind values are based on measured values recorded by a plurality of vehicles of a fleet using wind sensors and shared with the server external to the vehicle.

### BACKGROUND AND SUMMARY OF THE INVENTION

Exemplary embodiments of the invention relate to a method for the energy-optimal specification of a current vehicle speed at a selected desired average speed, taking into account a wind distribution along the route.

Static or adaptive cruise control systems have long been known from the general prior art. They have been used in the USA since the 1950s and in Europe since the early 1960s. The cruise control system keeps a specified speed constant (static) and/or automatically adapts to the traffic situation (vehicle in front/speed limit) in the case of adaptive cruise control (ACC).

It is generally assumed that, for physical reasons, the fuel consumption when driving with cruise control is lower than when driving without it at the same average speed, as the speed fluctuates around the average speed even for experienced drivers when driving manually. The energy consumption for overcoming air resistance is proportional to the square of the speed. The sections of the journey travelled at speeds above the average speed therefore lead to more fuel consumption than is saved in the sections of the journey at below-average speeds. However, this only applies if there is no additional force acting on the vehicle, such as wind in particular.

Novel theoretical approaches such as in Jia et al. 2019, Energy-Optimal Adaptive Cruise Control for Electric Vehicles in Both Time and Space Domain based on Model Predictive Control, IFAC-PapersOnLine, Volume 52, Issue 5, 2019, pages 13-20, exist and optimize the current adaptive cruise control according to the current traffic situation, in particular depending on the distance to the vehicles in front, taking into account, for example, the drive-specific characteristics of battery electric vehicles.

The change in the required force depending on the wind acting on the vehicle is described, for example, in Göhring E., Krämer W. (1985-1986) Auswirkung aerodynamischer Maßnahmen auf Kraftstoffverbrauch und Fahrleistung moderner Nutzfahrzeuge—Teil 1-3. (Effect of Aerodynamic Measures on Fuel Consumption and Driving Performance of Modern Commercial Vehicles—Parts 1-3) ATZ Automobiltechnische Zeitschrift.

The publication US 2019/0283602 A1 describes a method for energy-optimal cruise control. An optimum target speed is determined for each future route segment in accordance with a desired average speed on the basis of fundamental physical laws, such as rolling friction and empirical vehicle characteristics.

The publication US 2019/0283602 A1 also considers weather data, including wind. The optimized planning of the vehicle speed is based on wind forecasts for future route sections. However, accurate wind forecasts are extremely difficult to generate. It is not only the general wind direction that plays a role in the wind distribution along a road, but also the development, the location of elevations on the landscape, valleys, vegetation areas, and the like. Wind forecasts are therefore usually subject to a high degree of error, especially in regions with a varied landscape.

A device for regulating a driving speed is known from DE 10 2019 004 883 A1. Here, the wind speed around or in front of a vehicle is detected in order to be able to adjust the speed accordingly depending on whether there is a headwind or a tailwind. In the context of an extension of the device, it is also described that its own measurements can be combined with external measurements, which are recorded, for example, by a fleet of vehicles and transmitted to a central server.

Further prior art can also be found in DE 10 2018 221 264 A1. This describes how the wind speed can be derived from a change in the driving data, in particular the recorded drive power and direction of travel, without the need for a wind sensor.

DE 10 2015 000 394 A1 describes a vehicle fleet-based measurement of environmental data that is transmitted to a server device. Measurement inaccuracies, such as those caused by noise, are compensated for using probability values or a probability density value.

Exemplary embodiments of the present invention provide an improved method that does not require such wind forecasts.

In this method, the statistical wind distribution is generated based on local wind values, which are based on measured values recorded by a large number of vehicles in a vehicle fleet with suitable wind sensors and shared with a server external to the vehicle, instead of the often error-prone wind forecast, which is very complex to generate. This server aggregates the individual measured values and provides the wind values generated in this way for several consecutive positions along a planned route or their local region.

The method therefore makes use of a plurality of vehicles in a vehicle fleet being in a communication link with the server external to the vehicle and sharing the data from wind sensors with this server external to the vehicle. This allows an up-to-date database of the wind conditions to be created as a table, characteristic map, or preferably as a wind map, in particular for recording crosswind situations. This makes it possible to calculate or derive the wind distribution from these wind values along the planned route much better and more reliably than with forecasts based on weather models, and therefore to provide them. This allows the wind conditions to be used and the vehicle speed to be adjusted by means of a cruise control system such that a desired and specified average speed can be achieved in an energy-optimal manner.

From a plurality of recorded values for each location, which originate from the corresponding plurality of vehicles in the fleet with the wind sensors, a location-dependent wind probability density function can then be created in accordance with the method according to the invention for each available location, i.e., for each location for which the corresponding wind values or measured values are available, depending on the wind magnitude and the wind angle. This can now be used for the energy-optimal cruise control.

Preferably, according to an extraordinarily favorable further development of the method according to the invention, a probability density function of the wind, and here in particular of the crosswind, is calculated along the route using the planned route by means of the location-dependent wind probability density functions. This provides the statistically expected wind values along the entire route. If the wind situation changes significantly, which can be detected by the wind values or measured values of the individual vehicles in the fleet that continue to be transmitted, then this wind probability density function can also be updated or readjusted along the route if necessary.

According to a very advantageous further development of the idea, the measured values comprise the magnitude of wind speed, i.e., the magnitude of wind force, as well as the wind direction. A very favorable embodiment can then provide for the wind values to be formed by a temporal and/or local averaging of the measured values.

According to another very favorable embodiment, it can be provided that the measured values are weighted according to the time span between the use of the measured values and their measurement. This means, for example, that in the case of temporal and/or local averaging, measured values from further back can be given less weight in the mean value than corresponding current measured values. In particular, the weighting can also be set to a weighting factor of zero after a certain period of time has elapsed since the measurement, such that older measured values are no longer taken into account after a predetermined “validity period” has elapsed.

Other information collected locally can also be used in the aggregation. The traffic situation, for example, can be taken into account. By way of example, the number of vehicles in the lane or the opposite lane, the speed of the vehicles, and the type and number of parked vehicles alongside the vehicle or other conditions that could influence the wind conditions can be used for this purpose. If this data is collected during the wind measurement and taken into account accordingly, the distribution of measured values can be reduced, for example, by weighting measured values less heavily in the case of vehicles passing close by during the measurement or, if necessary, discarding them completely.

A particularly advantageous embodiment of the method according to the invention can now provide that a threshold function value is defined based on the wind probability density along the route by means of an optimization method, which divides the area spanned by the magnitudes of the wind speed and the wind angle into two ranges in such a way that in one range the vehicle speed can be increased without having to apply more net force and in the other range the vehicle speed must be reduced in order not to have to apply more net force. The threshold value function therefore provides the ranges in which the vehicle can be driven faster than the specified average speed without additional effort in order to correspondingly save time. In the other range, the wind conditions are such that a slower driving style is necessary in order not to require more force than desired. Based on the route and the desired average speed, these ranges can now be utilized in such a way that the vehicle is driven faster in certain ranges in order to be driven correspondingly slower in other ranges, and thus to save energy along the route.

It is particularly easy to optimize for efficiency if, as is provided according to an exceptionally favorable development of this idea, a current measured value is recorded by the vehicle in order to determine the current wind value, after which its position is determined in one range or the other, or in the borderline case also on the threshold value function itself. If the position is in one range, the speed is increased accordingly, either dynamically or by a fixed predetermined speed magnitude, and in the other range it is reduced accordingly. This makes it possible to implement extremely simple and efficient control, in particular if the wind probability density along the route and the threshold function are determined in advance, for example by the server external to the vehicle. With minimal computing effort and optimized use of the available resources, an energy-optimized speed adjustment can be carried out during the journey simply by comparing the currently recorded measured value with the threshold value function. If the recorded measured value lies directly on the threshold value function, the speed can be kept constant accordingly in order to complement this.

As already mentioned above, according to a very advantageous development of the method according to the invention, an update of the wind probability density can be provided in the case of changing measured values from the fleet of vehicles.

A further very favorable embodiment additionally takes into account the drag coefficient or c_{W}-value of the corresponding vehicle, which is also wind-dependent, in particular depending on the wind angle. Any crosswind that may occur can thus be taken into account and included in the optimization for determining the threshold value function.

Further advantageous embodiments of the method according to the invention also emerge from the exemplary embodiment, which is described in detail below with reference to the figures.

### BRIEF DESCRIPTION OF THE DRAWING FIGURES

Here are shown:

FIG. 1 an overview explaining the method;

FIG. 2 an example explaining the location- and time-resolved aggregation of measured values from a vehicle fleet;

FIG. 3 a wind probability density according to the invention based on the corresponding data;

FIG. 4 the creation of a wind probability density along a planned route;

FIG. 5 provision of the wind probability density created according to FIG. 4 along a planned route for a vehicle;

FIG. 6 the creation of a globally optimized threshold function;

FIG. 7 a diagram and a schema illustrating the correlation between the air friction force and the wind angle;

FIG. 8 an analogue depiction of FIG. 7 to explain the correlation between the difference in air friction force in the case of changing speed depending on the wind angle;

FIG. 9 a diagram for schematically explaining the correlations for optimization to achieve the threshold value function;

FIG. 10 a threshold value function within the wind probability density with the two ranges;

FIG. 11 a depiction analogous to that in FIG. 10 having two sub-ranges of the respective ranges;

FIG. 12 a depiction of the case in FIG. 11 in a probability/force diagram; and

FIGS. 13a and 13b a flow chart explaining a possible execution of the method according to the invention.

### DETAILED DESCRIPTION

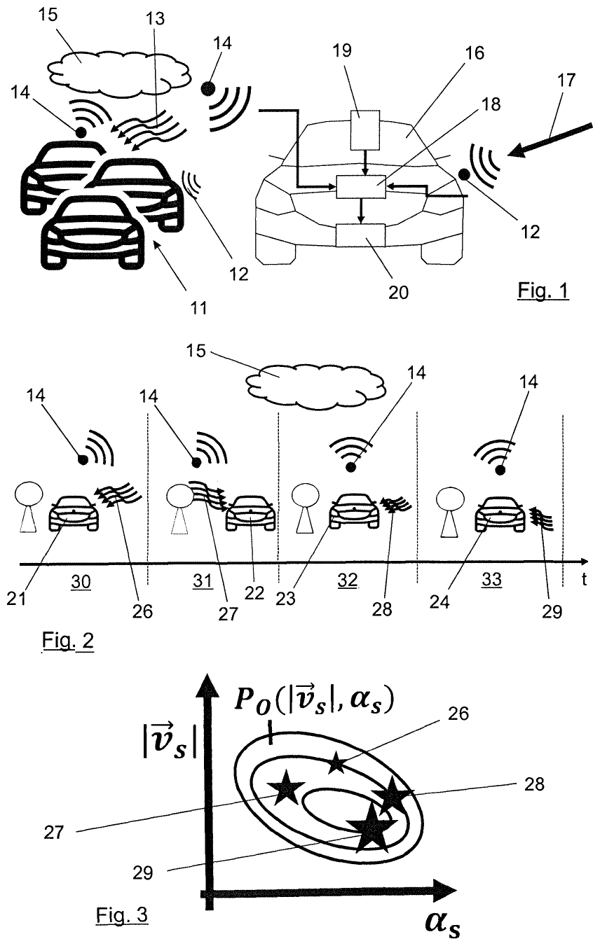

FIG. 1 shows a fleet 11 of vehicles that record measured values via (cross) wind sensors 12 on vehicles. These measured values include the current wind speed magnitudes and directions. A fleet 11 therefore uses the wind sensors 12 to measure the wind conditions 13 in a spatially and temporally resolved manner. It sends this information to a server external to the vehicle, e.g., a cloud/data center 15, by means of a data communication unit 14. This information is aggregated there and a spatially and temporally averaged (cross) wind distribution is created. The wind values can be stored in various ways, e.g., in a table, a characteristic map or, particularly preferably, in a digital wind distribution map. Such crosswind distribution maps can locally average currently measured wind speed magnitudes and directions and further characterize them with a probability distribution P of the values. This utilizes the fact that a large number of vehicles in the fleet 11 travel to the same location with relatively short time differences and these values determined in this way can be averaged over a period of time. Advantageously, previous crosswind distribution maps can be stored (time-dependent) and used as starting values for currently determined crosswind distribution maps. By way of example, crosswind distribution maps can be subject to seasonal fluctuations.

For each location O, as indicated in FIG. 2, the wind information 26-29 is measured by various vehicles 21-24 of the fleet 11 at various points in time 30-33, wherein 33 indicates the current point in time and 30-32 indicate past points in time, and is forwarded to the cloud/data center 15 by means of the data communication unit 14, and this location- and time-resolved wind information is aggregated there.

Advantageously, the information is aggregated in such a way that a location-dependent wind probability density function

$${P}_{O} ( \vert {\vec{v}}_{s} \vert , {α}_{s} )$$

of the wind magnitude (|vₛ|) and the wind direction or the wind angle (αₛ) as depicted in FIG. 3 is created for each location O. For this purpose, the wind information 26-29 is processed weighted according to its temporal component, for example, older information is weighted less heavily than more recent information. This is indicated in FIG. 3 by the different sizes of the stars, which symbolize the wind information 20-23 in the wind probability density P_{O} of FIG. 3. The individual areas surrounded by the rings or ovals represent different value ranges of the probability density.

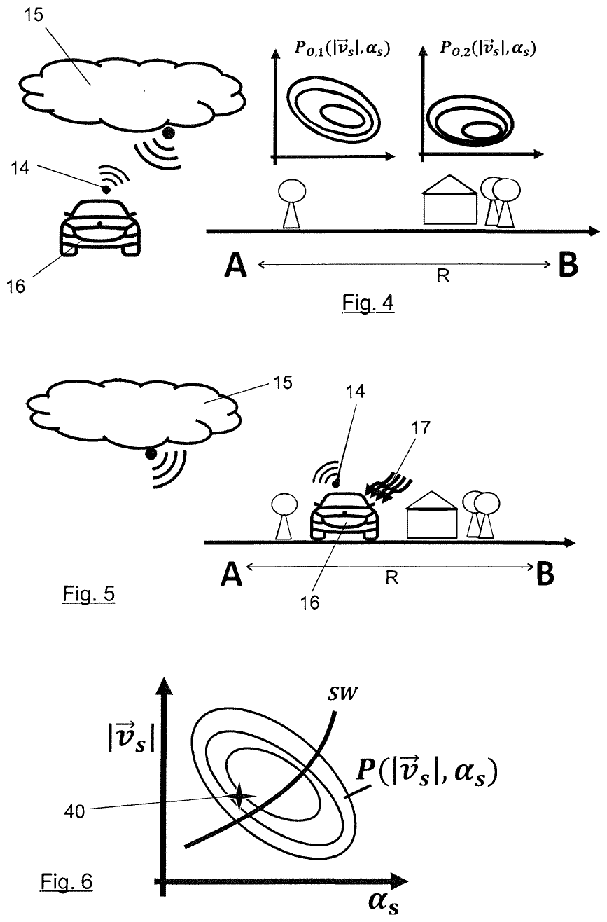

The aggregated information can then be transmitted to vehicles in the fleet 11. In FIG. 1, the aggregated location- and time-resolved wind information is transmitted to a vehicle 16 via a data communication unit 14, for example. If the vehicle 16 now starts a journey, a navigation system 19 is used to calculate a route R from the starting location A to the destination B and is combined with the information from the crosswind distribution map to form a probability distribution P of the crosswind conditions on the route R, as indicated in FIG. 4.

For a planned route R from A to B of the vehicle 16, information on the location-resolved wind probability density functions

$${P}_{O , i} ( \vert {\vec{v}}_{s} \vert , {α}_{s} )$$

is determined for each location O on the route and combined to form a wind probability distribution P for the entire route, as can be seen schematically in FIG. 5.

The information can be processed either locally in the vehicle 16 or in the data center 5; in the former case, the location-resolved wind probability densities must be sent to the vehicle 16, in the latter case, the route information must be sent to the data center.

For the planned route A to B of the vehicle 16, a decision function or a threshold value function SW is defined by means of an optimization method based on the wind probability distribution P of the overall route and, if necessary, further specifications, which will be discussed in more detail below, which divides the scope of the wind speeds and angles into two ranges, as depicted in FIG. 6.

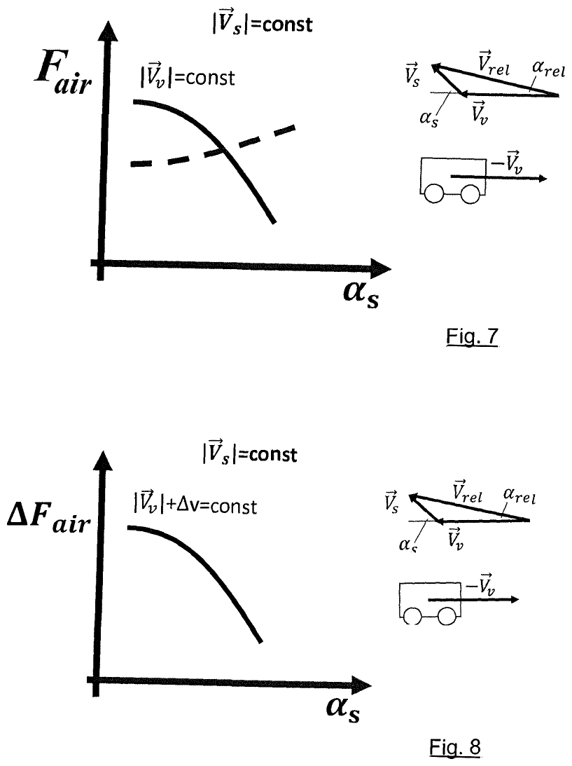

This is based on the following considerations explained with reference to FIG. 7ff: the air friction force Fₐᵢᵣ (solid curve) to be generated when travelling at a constant speed |vᵥ| (the bold print symbolizes a vector) is dependent on the wind angle as if the wind speed |vᵥ| is at a constant magnitude and the drag coefficient c_{W} is constant (i.e. not assumed to be dependent on the wind angle). With an increasing wind angle αₛ, which is an element of the set between 0° and 180°, the air friction force Fₐᵢᵣ decreases, as the magnitude |vᵣₑₗ| of the relative speed of the incoming air decreases as the vector sum of vᵥ and vₛ according to the formula

$${\vert {\vec{V}}_{rel} \vert}^{2} = {\vert {\vec{V}}_{v} \vert}^{2} + {\vert {\vec{V}}_{s} \vert}^{2} + 2 \vert {\vec{V}}_{v} \vert \vert {\vec{V}}_{v} \vert cos ( {α}_{s} ) .$$

In the trivial cases of αₛ=0° (maximum headwind) or αₛ=180° (maximum tailwind), the magnitude |vᵣₑₗ| is maximum or minimum. In general, the drag coefficient c_{W} increases with increasing relative angle of the incoming air αᵣₑₗ and at constant speeds with increasing wind angle αₛ (for example, quadratically) and the air friction force Fₐᵢᵣ increases for larger wind angles as, as illustrated by the dashed curve in FIG. 7.

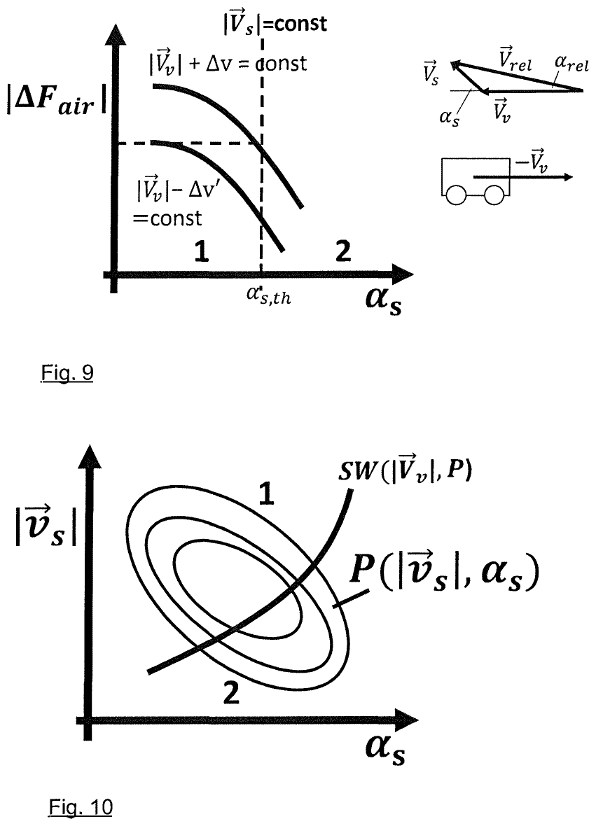

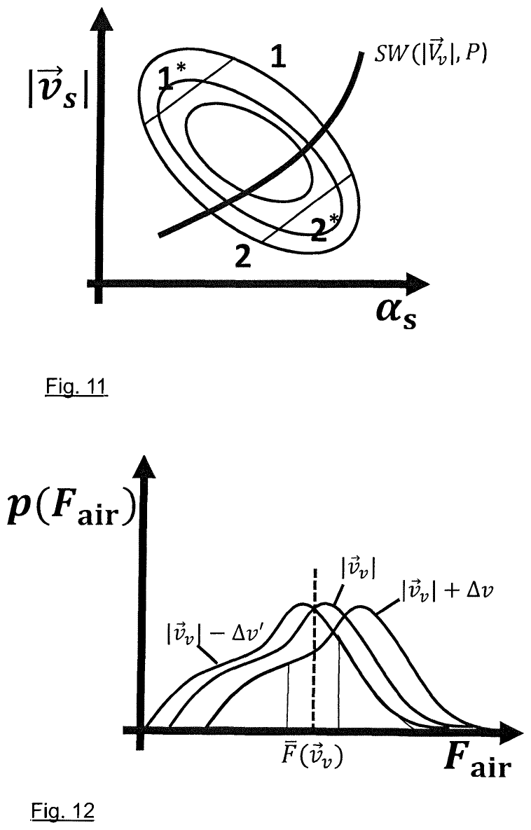

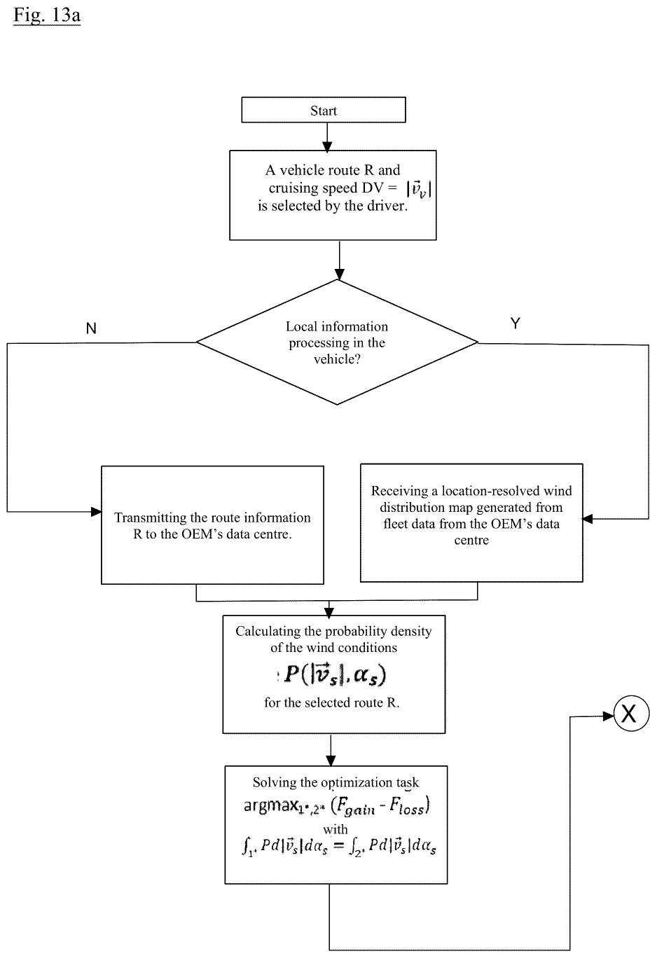

The difference in air friction force ΔFₐᵢᵣ to be generated when travelling at a constant speed |vᵥ|+Δv and at a constant speed |vᵥ| depicted in FIG. 8 depends on the wind angle αₛ for a constant magnitude of wind speed |vᵥ|. With an increasing wind angle αₛ, which is an element of the set between 0° and 180°, less additional air friction force ΔFₐᵢᵣ is required, as the magnitude |vᵣₑₗ| of the relative speed of the incoming air decreases as a vector sum of vᵥ and vₛ according to the above formula and is included in the force as a square, while the value of the generally wind angle-dependent drag coefficient c_{W} is assumed or approximated to be constant for each αₛ.

The air friction force Fₐᵢᵣ required when travelling at a constant speed |vᵥ| and the additional force ΔFₐᵢᵣ to travel at a faster speed Δv is dependent on the wind angle αₛ for a constant wind speed |vₛ|, as shown in FIGS. 7 and 8. As the wind angle as increases, the additional air friction force required ΔFₐᵢᵣ decreases (see FIG. 8). If the vehicle speed is now increased by Δv or decreased by Δv′, it results in the air friction force

$${F}_{air} ( \vert {\vec{V}}_{v} \vert + Δ v ) or {F}_{air} ( \vert {\vec{V}}_{v} \vert - Δ {v}^{′} )$$

$$and correspondingly \vert Δ {F}_{air} \vert to \vert {F}_{air} ( \vert {\vec{V}}_{v} \vert ) - {F}_{air} ( \vert {\vec{V}}_{v} \vert + Δ v ) \vert$$

$$or to {F}_{air} ( \vert {\vec{V}}_{v} \vert ) - {F}_{air} ( \vert {\vec{V}}_{v} \vert - Δ {v}^{′} ) .$$

From a threshold angle α_{s,th}, which generally depends on the magnitude of vehicle speed, the wind speed vector

$${\vec{V}}_{s} , i . e . \vert {\vec{V}}_{s} \vert and {α}_{s}$$

as well as Δv′ and Δv (constant in FIG. 9), less additional air friction force is required at a speed higher by Δv than can be saved at a speed lower by Δv′ with a smaller angle. This means that if you travel slower at smaller wind angles, you can travel faster at larger wind angles without applying more force, provided that the magnitude |vₛ| of wind speed remains constant, at least on average. This results in two ranges (1, 2) in which the speed can be reduced (1) or increased (2) without having to apply more net force.

If

$$\vert {\vec{V}}_{v} \vert - Δ {v}^{′} = 1 / ( 2 / \vert {\vec{V}}_{v} \vert - 1 / ( \vert {\vec{V}}_{v} \vert + Δ v ) )$$

is selected, the average speed is just |vᵥ| even if the same section lengths are travelled at

$$\vert {\vec{V}}_{v} \vert + Δ v or \vert {\vec{V}}_{v} \vert - Δ {v}^{′}$$

and, if applicable, a remaining section at |vᵥ|.

In general, as shown in FIG. 10, there is a threshold value function SW for a probability density function P (|vₛ|, αₛ), which, depending on the vehicle speed |vᵥ| and the current wind conditions (|vₛ| and as), divides the range of all possible/probable wind conditions (i.e., ranges 1 and 2 together) into two ranges 1 and 2, wherein the vehicle speed can be reduced in range 1 and the vehicle speed increased in range 2 without having to apply more net force. As long as the distances of the total route sections travelled in range 1 and range 2 are the same, the average speed is then just |vᵥ|, as can be seen in FIG. 9. The threshold value function SW is advantageously determined by that of the force F, which must be applied as the average force given the wind probability distribution P.

For the location- and time-dependent probability density function P(|vₛ|, αₛ) obtained from the vehicle fleet and aggregated in the data center and calculated with the vehicle's route information, it is thus possible to determine for each current wind circumstance measured by the vehicle whether it is located in range 1 or 2, as well as the probability that this wind circumstance will occur on the route (the areas in the rings or ovals symbolize different value ranges of the probability density).

Integrating the product of the probability density function P, that a wind occurs for a pair of values |vₛ| und αₛ, with the air friction force given |vₛ|, αₛ und |vᵥ|, produces the total mean force required, i.e., the force that is required on average on the route with these wind conditions.

The probability density is of course normalized here, i.e., the integral of the probability density over the entire scope is:

$${\int }_{1 + 2} Pd \vert {\vec{v}}_{s} \vert d {α}_{s} = 1$$

Integrating the product of the probability density function P with the air friction force given |vₛ|, as and a speed |vᵥ|+Δv increased by Δv in range 2, produces the total mean force Fₗₒₛₛ required to drive Δv faster.

$${F}_{loss} = {\int }_{2} P ( \vert {\vec{v}}_{s} \vert , {α}_{s} ) \cdot {F}_{air} ( \vert {\vec{v}}_{s} \vert , {α}_{s} , {\vec{v}}_{v} + Δ v ) d \vert {\vec{v}}_{s} \vert d {α}_{s}$$

Integrating the product of the probability density function P with the air friction force given |vₛ|, as and a speed |vᵥ|−Δv′ decreased by Δv′ in range 1, produces the total mean force F_{gain} required to drive Δv′ slower.

$${F}_{gain} = {\int }_{1} P ( \vert {\vec{v}}_{s} \vert , {α}_{s} ) \cdot {F}_{air} ( \vert {\vec{v}}_{s} \vert , {α}_{s} , {\vec{v}}_{v} - Δ {v}^{′} ) d \vert {\vec{v}}_{s} \vert d {α}_{s}$$

At any time t and the vectorial wind value valid at this time, a speed vᵥ to be travelled at can be selected with the knowledge of the forces described such that the total energy during the route is minimized.

By way of example, in a simple control, it is possible to calculate for each group element Fₐᵢᵣ(\vec{v}ₛ(t), \vec{v}ᵥ) whether the value is above or below F̅. If Fₐᵢᵣ(\vec{v}ₛ(t), \vec{v}ᵥ+Δv)<<F̅, the speed can be increased. In the case of Fₐᵢᵣ(\vec{v}ₛ(t), \vec{v}ᵥ−Δv′)>>F̅, the speed should be reduced, wherein the ratio of the two cases must be calculated and taken into account in order to implement a constant speed over the entire distance.

In general, two regions 1* and 2* in P, which are subsets of the ranges 1 and 2 respectively, can be determined under the condition that the total probability of both subsets is the same. To do so, the two regions 1* and 2* in P or the area spanned by |vₛ|, αₛ, are determined under the condition that

$${\int }_{{1}^{*}} Pd \vert {\vec{v}}_{s} \vert d {α}_{s} = {\int }_{{2}^{*}} Pd \vert {\vec{v}}_{s} \vert d {α}_{s} ,$$

and the speed in 1* is reduced by Δv′ and increased in 2* by Δv so the average speed is |vᵥ|. Furthermore, the two regions yield the total force gain from the difference between F_{gain} and Fₗₒₛₛ, with

$${F}_{gain} = {\int }_{{1}^{*}} P \cdot {F}_{air} ( {\vec{v}}_{v} - Δ {v}^{′} ) d \vert {\vec{v}}_{s} \vert d {α}_{s}$$

$$and$$

$${F}_{loss} = {\int }_{{2}^{*}} P \cdot {F}_{air} ( {\vec{v}}_{v} + Δ v ) d \vert {\vec{v}}_{s} \vert d {α}_{s} .$$

The optimum ranges/regions 1* and 2* can be found using standard optimization methods: argmax_{1*,2*} (F_{gain}−Fₗₒₛₛ) with ∫_{1*} Pd|\vec{v}ₛdαₛ=∫_{2*} Pd|\vec{v}s|dαₛ.

This means that the current control in the vehicle results from the optimum regions and the current wind conditions, i.e., whether you are in region 1*, 2* or outside of them is determined by the current wind conditions.

Furthermore, the vehicle-specific drag coefficient c_{w} is generally dependent on the relative angle of the incoming air αᵣₑₗ, which in turn is constituted by the angle of the occurring crosswind as, as well as vᵥ and vₛ, and can be taken into account during optimization. In particular, the vehicle-specific drag coefficient c_{w} can increase with an increase in αᵣₑₗ (and thus be reduced by increasing the speed). Details on this are generally known and can be found, for example, in the prior art mentioned in the introduction, e.g., by Göhring and Krämer (1985 and 1986).

In a further embodiment, the average speed on various route sections i can be changed automatically, e.g., based on route-dependent speed limits and/or manually by the driver's choice. Each route section i is then considered as a separate route and the optimum control strategy of the adaptive cruise control systems (CCS) is calculated for each route section i.

During the journey, the vehicle 16 measures the current local wind direction and wind speed (designated 17 in FIG. 1 and FIG. 5). Based on the value currently measured at the point in time to, it is checked whether said value is above or below the decision function or threshold value function SW. If the value is above the threshold value function SW, the speed can be reduced by a fixed value Δv′, thereby saving energy. The decision function or the threshold value function SW has just been optimized before the start of the journey in such a way that the speed can be increased by a fixed magnitude Δv at a different point in time tₓ and other currently measured wind conditions in order to achieve a specified average speed |vᵥ| on the route and at the same time require less energy for the faster journey at the point in time tₓ than is saved at the point in time to. See FIG. 6, reference numeral 40.

Furthermore, this control is particularly energy-efficient, as the optimum threshold value function SW only has to be calculated once, and the measured wind value in relation to the threshold value function SW is sufficient at any time to decide whether the vehicle should travel at a higher than average, slower than average or average speed.

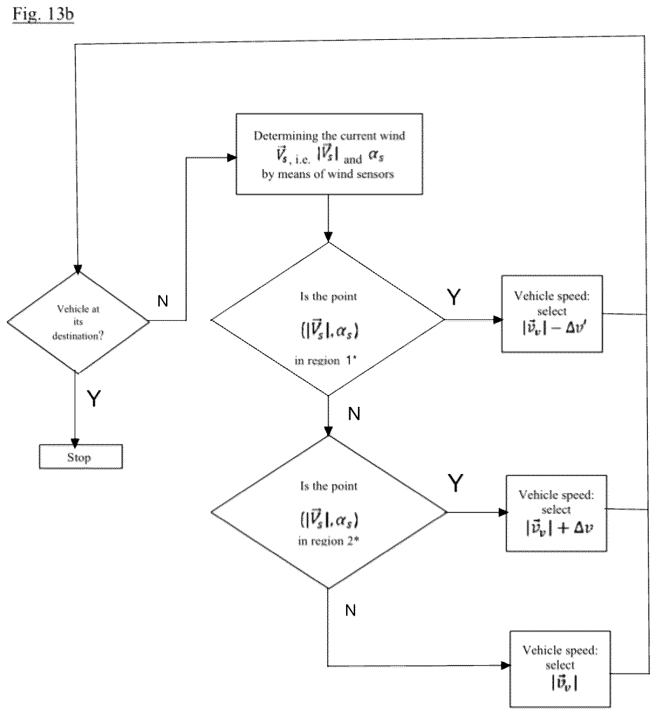

FIG. 13a and FIG. 13b illustrates a flow chart of the method. The sequence begins at the top of FIG. 13A with the start of the method. A route R and a travelling speed in the form of the average speed are selected by the driver of the vehicle 16. The subsequent decision diamond determines whether the information is processed in the vehicle 16 itself or in the server 15 external to the vehicle. In the one case, the route information is transmitted to the data center, in the other case the location-resolved fleet data and the wind map generated from it are transmitted to the vehicle 16. The probability distribution P of the wind conditions for the selected route R is then calculated either in the vehicle 16 or on the server external to the vehicle, and the optimization task described above is solved, i.e., the threshold value function SW is determined.

The method sequence then jumps to the second part shown in FIG. 13b. Here, the basic check is carried out to determine whether the vehicle 16 has reached its destination, i.e., destination B in the above exemplary embodiments and the figures. If this is the case, the method is stopped. As long as this is not the case, the current wind conditions around the vehicle 16 are determined with the help of its wind sensors 12. It is then checked whether the measured value recorded is in region 1* or region 2*. In the first case, the vehicle speed |vᵥ| is reduced by Δv′; in the case of being in region 2*, the driving speed |vᵥ| is correspondingly increased by Δv. If the current measured values are neither in region 1* nor in region 2*, i.e., between these regions and in particular within the range of the threshold value function SW, the driving speed |vᵥ| is left at the average driving speed |vᵥ| or, if it has been changed beforehand, is reset to this speed. This process is repeated until the vehicle 16 has reached destination B.

A first theoretical exemplary embodiment clarifies the principle of the method. A vehicle 16 travels a route s with a constant wind speed vₛ from two different directions αₛ=0° (frontal headwind) und αₛ=450 (headwind from the front right). The different wind directions are equally distributed, i.e., the probability of αₛ=0° is equal to the probability of αₛ=45°, over the total distance s. By way of example, the angle could be αₛ=0° on the first section s/2, and αₛ=45° on the second section. If the vehicle 16 now travels at a speed reduced by Δv′ on the first section and increased by Δv on the second section, the total energy is W=W1+W2=F1*s/2+F2*s/2 with F1=γ*(|vᵥ|−Δv′+vₛ)² and F2=γ*(vᵣₑₗ)², wherein vᵣₑₗ² is a function of |vᵥ|+Δv and αₛ=45° is constituted by (|vᵥ|+Av)²+vₛ²+2(|vᵥ|+Av)vₛ/√2, and γ contains all constant factors or factors assumed to be constant (i.e. air density, drag coefficient, area).

In a practical exemplary embodiment, the method is described as follows. A vehicle selects a route along California State Route 1 (CA 1 or Highway 1 for short) from Manchester State Park to San Francisco. The route-related wind probability density results in high probabilities for constant headwinds from different directions with different magnitudes. This means that the route-related wind probability density has high probability values in a small angle range as, for example between 0° (front headwind) and a crosswind of 45°. The speed distribution is also normally distributed around 30 km/h with a variance of 10 km/h, for example. Based on the route-related wind probability distance, two regions 1* and 2* are now found, for which the difference between the total force F+ to be expected due to the reduction in speed and the total force F− to be expected due to the increase in speed is maximum. When the vehicle 16 is travelling, its wind sensors 12 measure the present/current wind speed and direction. If this pair of values is in the region 1*, the vehicle speed is reduced by Δv′. The vehicle therefore travels more slowly if the wind angle is small and the speed is high. However, if this pair of values is in the region 2*, the vehicle speed is increased by Δv. The vehicle 16 therefore travels faster when the angle of the wind is relatively large (but the wind is still coming from the front) and the wind speed is low. In this situation, less net force is required as the gain, i.e. the difference between F+ and F− is positive, and the average speed remains constant vᵥ.

Although the invention has been illustrated and described in detail by way of preferred embodiments, the invention is not limited by the examples disclosed, and other variations can be derived from these by the person skilled in the art without leaving the scope of the invention. It is therefore clear that there is a plurality of possible variations. It is also clear that embodiments stated by way of example are only really examples that are not to be seen as limiting the scope, application possibilities or configuration of the invention in any way. In fact, the preceding description and the description of the figures enable the person skilled in the art to implement the exemplary embodiments in concrete manner, wherein, with the knowledge of the disclosed inventive concept, the person skilled in the art is able to undertake various changes, for example, with regard to the functioning or arrangement of individual elements stated in an exemplary embodiment without leaving the scope of the invention, which is defined by the claims and their legal equivalents, such as further explanations in the description.

1-10. (canceled)

11. A method for the energy-optimal specification of a current vehicle speed at a selected desired average speed of a planned route, taking into account a wind distribution along the planned route, the method comprising:
providing, by a server external to the vehicle, the wind distribution in a form of wind values for several successive positions along or in a local region of the planned route, wherein local wind values are based on measured values recorded by a plurality of vehicles of a fleet using wind sensors and shared with the server external to the vehicle; and
creating a wind probability density function for each location along the planned route having at least one available measured value depending on a wind speed magnitude and a wind direction.

12. The method of claim 11, further comprising:
calculating a probability distribution of wind conditions on the planned route using the location-dependent wind probability density.

13. The method of claim 11, wherein the measured values comprise wind speed magnitudes and wind directions.

14. The method of claim 11, wherein the wind values provided by the server are aggregated by temporally or are spatially averaged measured values.

15. The method of claim 11, wherein the measured values are weighted according to a time interval between use of the measured values and the recording of the measured values, wherein the weighting involves a weighting factor that becomes smaller as the time interval increases.

16. The method of claim 14, wherein the aggregation of the wind values uses further parameters in the aggregation, wherein the further parameters are determined at a time of recording the measured value at the location, wherein the further parameters represent a traffic situation.

17. The method of claim 11, wherein, based on the basis of the wind probability distribution along the route, a threshold value function is defined by an optimization method, wherein the threshold value function divides an area of the wind speed magnitude over the wind direction into two ranges in such a way that in one of the two ranges the vehicle speed is increasable without having to apply more net force, and in another one of the two ranges the vehicle speed must be reduced in order not to have to apply more net force.

18. The method of claim 17, wherein a current measured value recorded by the vehicle is used to determine current wind values, whereupon a position of a current wind value of the current wind values in the one or the another range of the two ranges or on the threshold value function is determined, wherein the speed is increased in case of a position in the one of the two ranges, the speed is reduced in case of a position in the another one of the two ranges, and the speed is left constant case of a position on the threshold value function.

19. The method of claim 11, wherein values of the wind distribution are updated by the vehicles of the fleet as measured values change.

20. The method of claim 18, wherein a dependence of drag coefficient on the wind values is also accounted for when determining the threshold value function.

21. A method comprising:
planning, by a vehicle, a route;
receiving, by a vehicle from a server external to the vehicle, a wind distribution in a form of wind values for several successive positions along or in a local region of the planned route, wherein local wind values are based on measured values recorded by a plurality of vehicles of a fleet using wind sensors and shared with the server;
controlling a current speed of the vehicle along the planned route at a selected desired average speed accounting for the wind distribution along the planned route and employing a wind probability density function for each location along the planned route having at least one available measured value depending on a wind speed magnitude and a wind direction.
